(19) United States
(12) Patent Application Publication
(10) Pub. No.: US 2012/0066550 A1
(43) Pub. Date: Mar. 15, 2012

(54) APPARATUS, SYSTEM AND METHOD FOR INTEGRATED TESTING OF SERVICE BASED APPLICATION

(75) Inventors: Chang-Sup KEUM, Daejeon-si (KR); Hyun-Joo Bae, Daejeon-si (KR); Byung-Sun Lee, Daejeon-si (KR)

(73) Assignee: Electronics and Telecommunications Research Institute, Daejeon (KR)

(21) Appl. No.: 13/227,430

(22) Filed: Sep. 7, 2011

(30) Foreign Application Priority Data
Sep. 7, 2010 (KR) 10-2010-0087418

(51) Int. Cl. G06F 11/36

(52) U.S. Cl. 714/38.1; 714/E11.207

(57) ABSTRACT

A service based application integrated testing apparatus, system and method is provided. The service based application integrated testing apparatus comprises an application integrated testing unit performs an integrated test on the at least one component service and the service based application by use of a control flow and a data flow, which are generated from an interaction between the at least one component service and the service based application.

### CROSS-REFERENCE TO RELATED APPLICATION

This application claims the benefit under 35 U.S.C. §119(a) of Korean Patent Application No. 10-2010-0087418, filed on Sep. 7, 2010, the disclosure of which is incorporated by reference in its entirety for all purposes.

### BACKGROUND

1. Field

The following description relates to a network based consumer oriented integration service technology, and more particularly, to a technology for integrated testing of an application and a component service.

2. Description of the Related Art

A component service provides data and services in a logical functional unit to other application while operating individually on a network. The communication between a component service and an application is achieved through standardized web protocols and data formats, for example, a Hypertext Transport Protocol (HTTP), an eXtensible Markup Language (XML) and a Simple Object Access Protocol (SOAP). In this manner, data flow is improved between all kinds of system regardless of the type of platform such as operating system (OS).

The component service may be provided by itself. Alternatively, the component service may be composed together with other component services into a reusable block for a service based application (hereinafter, referred to as “application”) to perform a business function of the application.

However, since the component service developed by a third party is provided in the form of a black box in the application, the internal operation of the application is not easily figured out. Accordingly, it is not easy to guarantee the quality of the application, which corresponds to a composition result of component services. The quality of an application is guaranteed by detecting errors through systematic test and correcting the errors.

### SUMMARY

In one aspect, there is provided a technology for integrated testing of an application and a component service.

In one general aspect, there is provided an apparatus for integrated testing of a service based application, the apparatus comprising an application integrated testing unit configured to analyze a control flow and a data flow, which are generated from an interaction between at least one component service and a service based application, and perform an integrated test on the at least one component service and the service based application based on a result of the analysis.

The apparatus includes a test model conversion unit configured to convert a scenario specification, which represents an interaction between the component service and the application with time, to a test model, which represents a flow of activities performed by the component service and the application, and a test cast generating configured to generated a test case from the converted test model, which is the test case used to test whether the component service and the application are normally provided.

In another general aspect, there is provided a system for integrated testing of a service based application. The system includes at least one component service apparatus configured to provide component services, an application apparatus configured to provide a service based application which is composed of the at least one component service, and an application integrated testing apparatus configured to generate a test case based on a control flow and a data flow, which are generated from an interaction between the component service apparatus and the application apparatus, executes the generated test case to perform the integrated testing on the component service and the service based application.

In another general aspect, there is provided a method for integrated testing of a service based application. The method is as follows. A test model converting unit converts a scenario specification between at least one component service apparatus and a service based application apparatus to a test model, which represents an activity flow between the component service apparatus and the service based application apparatus. A test case generating unit generates a test case from the converted test model.

Accordingly, the example can perform an integrated test whether a component service and a service based application normally operate. Different from testing a component service and an application individually, the integrated test of a component service and an application guarantees the quality of the application, which corresponds to a composition result of individual component services, and improves the stability and reliability of the application.

Further, by using the control flow and data flow generated from the interaction between the component service and the application in the integrated test, errors in the control flow and the data flow may be precisely detected that may be generated during composition of the component service and the application in advance.

Further, a test model is automatically generated based on a scenario specification and a test case is automatically from the test model, so that the time required for the integrated testing of the application is reduced.

Further, the example provides a stable and reliable business process, thereby preventing fatal errors that may be generated during an actual operation and thus reducing the operation expense of a business.

Other features will become apparent to those skilled in the art from the following detailed description, which, taken in conjunction with the attached drawings, discloses exemplary embodiments of the invention.

### BRIEF DESCRIPTION OF THE DRAWINGS

FIG. 1 is a block diagram illustrating an example of an apparatus for an integrated testing of a service based application.

FIG. 2 is a block diagram illustrating an example of a test model conversion unit of FIG.

FIG. 3 is a block diagram illustrating an example of a system for an integrated testing of a service based application.

FIG. 4 is a flowchart illustrating an example of a process of converting a test model.

FIGS. 5A to 5C are diagrams illustrating a process of converting a message sequence chart to an activity diagram.

FIG. 6 is a flowchart illustrating an example of a process of generating a test case.

Elements, features, and structures are denoted by the same reference numerals throughout the drawings and the detailed description, and the size and proportions of some elements may be exaggerated in the drawings for clarity and convenience.

### DETAILED DESCRIPTION

The following detailed description is provided to assist the reader in gaining a comprehensive understanding of the methods, apparatuses and/or systems described herein. Various changes, modifications, and equivalents of the systems, apparatuses and/or methods described herein will suggest themselves to those of ordinary skill in the art. Descriptions of well-known functions and structures are omitted to enhance clarity and conciseness.

Hereinafter, examples will be described with reference to accompanying drawings in detail.

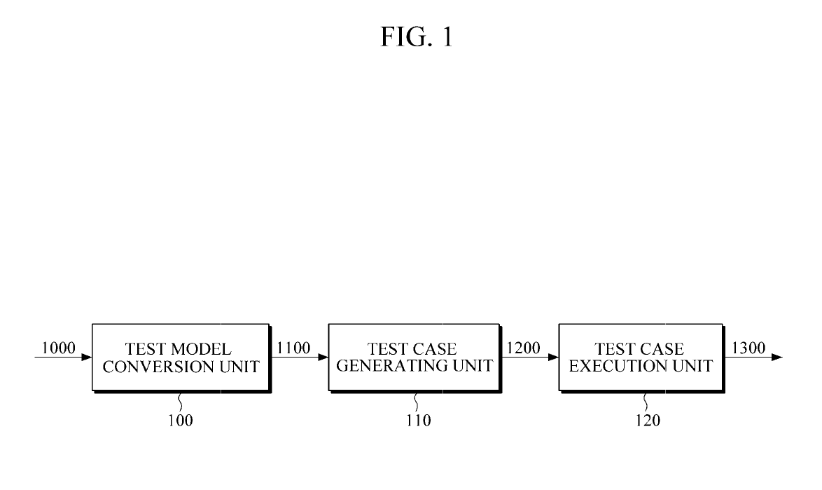

FIG. 1 is a block diagram illustrating an example of an apparatus for an integrated testing of a service based application.

Referring to FIG. 1, an apparatus for integrated testing of a service based application (hereafter, referred to as “application integrated testing apparatus”) 10 includes a test model conversion unit 100 and a test case generating unit 110, plus a test case execution unit 120.

The application integrated testing apparatus 10 tests the functionalities of a component service and a service based application (hereafter, referred to as ‘application’) in an integration manner. To this end, the application integrated testing apparatus 10 analyzes a control flow and a data flow, which are generated from the interaction between the component service and the application.

A component is a set of a plurality of objects that are formed based on database and a manipulation of database, and implements a single function that is associated with these objects. Similar to composing parts, a user may compose components.

The component service provides an application with data and service in a logical function unit. The application is provided in the form of a composition of component services. The component service may be used individually. Alternatively, the component service may be composed with other component services in the form of a reusable block of an application to perform a business function that is required by an application. An example of the component service is provided using a single component service or a plurality of component services.

According to this example, the component service and the application is subject to a integrated test. Such an integrated test guarantees the quality of an application corresponding to a result of composition of component services, as compared to testing the component service and the application individually. In addition, this example improves the stability and reliability of an application by applying a control flow and a data flow, which are generated from an interaction between the component service and the application, to the application test.

Hereinafter, the configuration of the application integrated testing apparatus 10 will be described in detail.

The test model conversion unit 100 converts a scenario specification 1000 to a test model 1100. The scenario specification 1000 represents an interaction between a component service and an application according to time. The test model 1100 represents the flow of activities that are performed by the component service and the application.

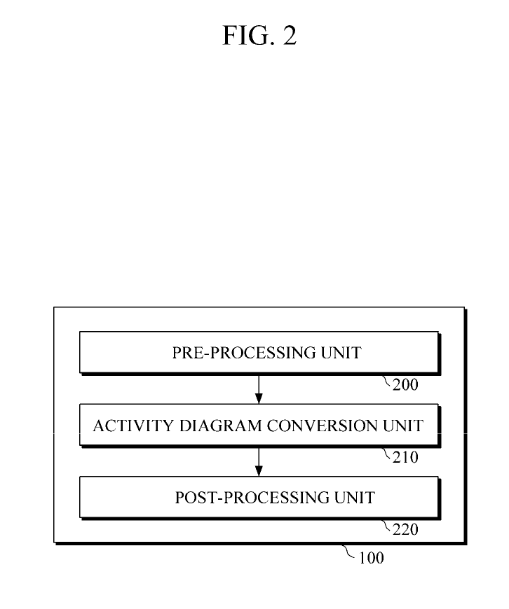

According to an example, the test model conversion unit 100 converts the scenario specification 1000 to the test model 1100 by use of an activity diagram of an unified modeling language (UML). The UML activity diagram shows a system interaction, work flow, message transfer between objects, system architecture and component relationship by use of UML. The configuration and process for converting the scenario specification 1000 to the test model 1100 in the test model conversion unit 100 will be described later with reference to FIGS. 2, 4 and 5.

The test case generating unit 110 generates a test case 1200 from the test model 1100. The test case 1200 is used to test whether the component service and the application are normally provided. The test case 1200 is configured to detect errors in the control flow of message transfer and the data flow between the application and the service component.

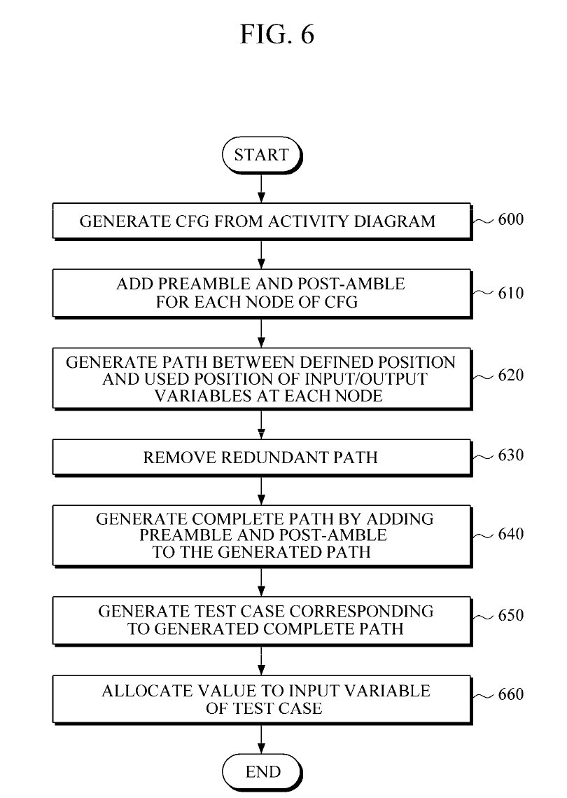

The test case 1200 includes the definition of execution functions. The execution functions are configured to test whether the application and the component services operate according to a message transmission/reception sequence, which is defined in the scenario specification 1000, in association with each other. Accordingly, in the test case 1200, it is tested whether web services normally operate according to the message transmission/reception sequence defined in the scenario specification 1000. A process of generating the test case 1200 in the test case generating unit 110 will be described later with reference to FIG. 6.

As described above, the test model conversion unit 100 automatically generates the test model 1100 based on the scenario specification 1000 and automatically generates the test case 1200 from the test model 1100. Accordingly, the time taken for the application testing is reduced. In addition, since the test case 1200 is automatically generated based on the message interaction between the component service and the application, the stability and the reliability of the test is improved as compared with a testing based on the experience of a tester.

The test case execution unit 120 performs a test on the service based application and the component services in an integrated manner. The test case execution unit 120 inputs a value of a parameter to the test case 1200, and tests whether the application operates according to a message transmission/reception sequence, which is defined in the scenario specification 1000, through the value.

If a message parameter value is input to the test case 1200, a set of executable test cases is generated, and the test case execution unit 120 performs an integrated test by use of the test cases. For example, when SOAP messages are sent having parameters, the test case execution unit 120 specifies a predetermined parameter value in the test case to test whether the application is provided according to the scenario specification 1000. The test case execution unit 120 may store results of the test, such as success, failure and deferred determination or may be output results of the test in a test result sheet 1300.

FIG. 2 is a block diagram illustrating an example of a test model conversion unit of FIG. 1.

Referring to FIG. 2, the test model conversion unit 100 includes a pre-processing unit 200, an activity diagram conversion unit 210 and a post-processing unit 220.

The pre-processing unit 200 defines a swim lane for an instance corresponding to each object of a scenario specification.

The activity diagram conversion unit 210 selects a predetermined pattern among message exchange patterns of a scenario specification, and converts the selected predetermined pattern to an activity diagram corresponding to a test model. Thereafter, a start label and an end label are generated before and after a message event at each activity diagram, and activity diagrams having the same label are connected to each other, thereby generating the entire activity diagram.

The post-processing unit 220 generates a start node and an end node in the entire activity diagram and removes the start label and the end label. In addition, the post-processing unit 220 adds pre-condition information and post-condition information about input/output variables to each message event in the form of an Objet Constraint Language (OCL).

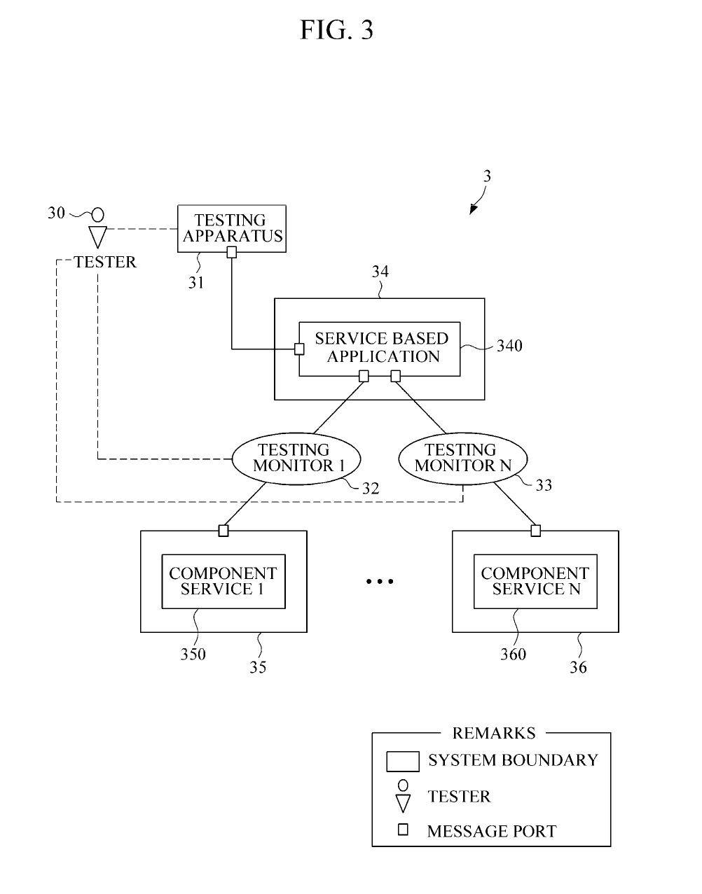

FIG. 3 is a block diagram illustrating an example of a system for an integrated testing of a service based application, hereinafter, referred to as “application integrated testing system”.

Referring to FIG. 3, an application integrated testing system 3 provides a testing architecture showing the interoperation of an application apparatus 34 and component service providing apparatuses 35 and 36, to perform a web service message transmission/reception. The component service providing apparatuses 35 and 36 include a first component service apparatus 35 and a N^{th} component service apparatus 36. The system shown in FIG. 3 implements the testing architecture in a physical aspect.

The testing architecture includes information about an operating environment where the application integrated testing is performed. The operating environment information may include the type and number of testing apparatuses and the position information about the testing apparatus and the testing monitor. The operating environment information may be input by a user or may be automatically generated according to an algorithm that is programmed based on the analysis of the scenario specification.

The component service providing apparatuses 35 and 36 provide the application apparatus 34 with component services including a first component service 350 and a N^{th} component service 360. A service based application 340 composes the component services 350 and 360 into the service based application 340. The application apparatus 34 provides a user with the application 34 that is composed of the component services 350 and 360. The component service providing apparatus 35 and 36 interoperate with the application apparatus 34.

A testing apparatus 31 executes the test case to test whether a web service message between the testing apparatus 31 and the application apparatus 34 satisfies a messaging procedure and input/output values that are described in the test case.

After the test case is executed, testing monitors (Point of Control and Observation) 32 and 33 tests whether a web service message between the component service providing apparatuses 35 and 36 and the application apparatus 34 satisfies a messaging procedure and input/output values which are described in the test case.

Hereinafter, the operation of the application integrated testing system 3 is described with reference to FIG. 3.

A tester 30 sends an input web service message, for example, Simple Object Access Protocol (SOAP) messages or Representational state transfer (REST) messages to a test object to be tested by executing the test case through the testing apparatus 31, and receives an output web service message, for example, SOAP messages or REST messages, from the test object. If an expected message is received from the testing apparatus 31, the test is determined as ‘success’. If the expected message is not received, the test is determined as ‘failure’. The test case is automatically generated through a test model conversion process and a test case generating processor.

The service based application 340, the first component service 350 and the N^{th} component service correspond objects to be tested. The service based application 340, the first component service 350 and the N^{th} component service 360 are mounted on the application apparatus 34, the first component service providing apparatus 35 and the N^{th} component service providing apparatus 36, respectively, and individually operate in a distributed environment. The number of components composed into a service based application is not limited.

The testing monitors 32 and 33 intercepts a web service message transferred between the component service providing apparatuses 35 and 36 and the application apparatus 34 to test or correct the contents of the web service message. When the testing monitors 32 and 33 checks the contents of the message, if the message is not what the test case expects, the test is determined as ‘failure’. If the message is what the test case expects, the test is determined as ‘success’.

The tester 30 makes a final decision on ‘success’ for a single test case by collecting test results that are generated at the testing apparatus 31 and the testing monitors 32 and 33. The tester 3 determines a final success when all of the testing apparatus 31 and the testing monitors 32 and 33 produces results of ‘success’.

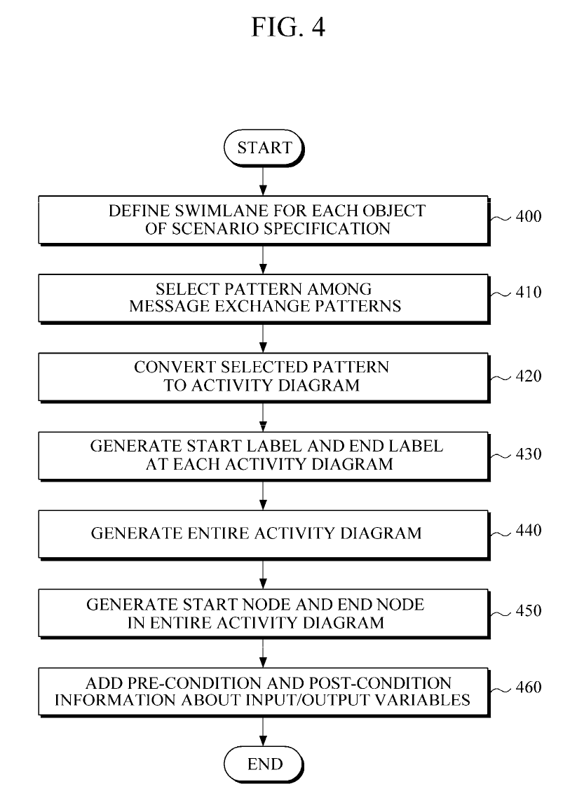

FIG. 4 is a flowchart illustrating an example of a process of converting a test model.

As shown in FIG. 4, the test model conversion unit 100 generates swim lanes for instances of a message sequence chart (MSC) of a scenario specification (400).

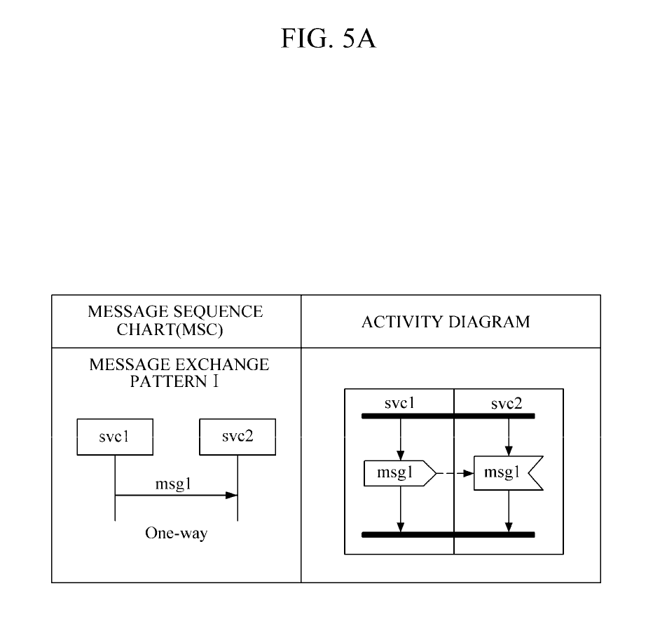

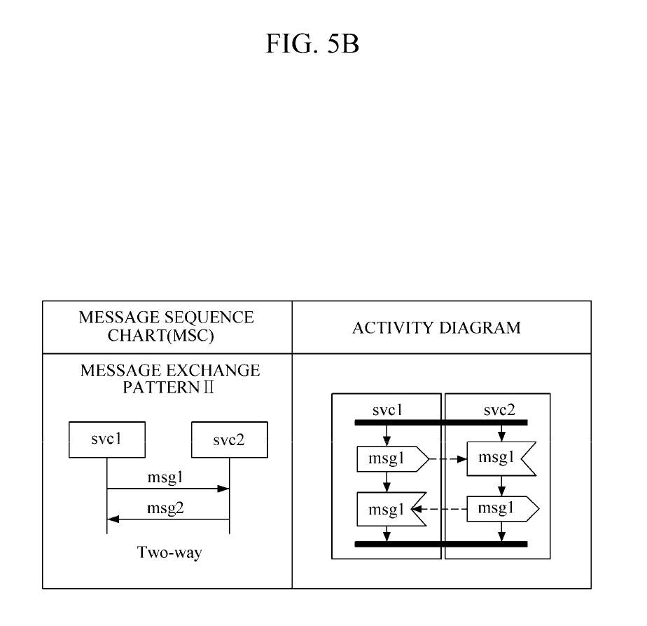

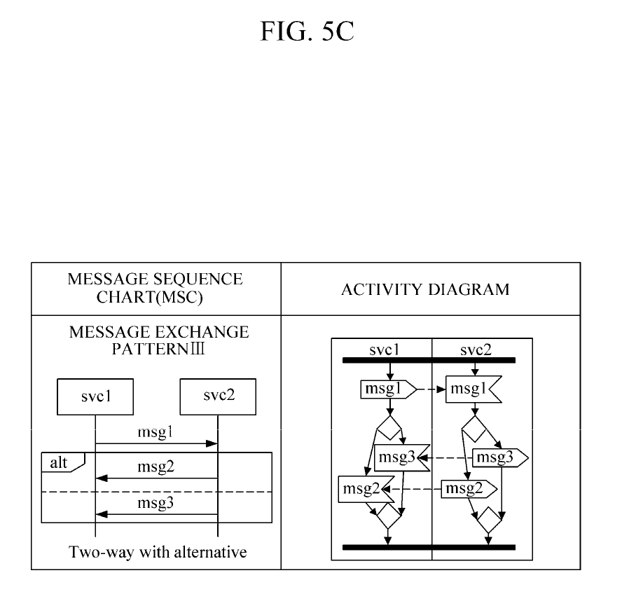

For example, svc 1 and svc 2 in a MSC fragment shown in the left part of FIG. 5A represent instances, and the squares surrounding the svc 1 and svc 2 in the right part of FIG. 5A represent swim lanes.

The test model conversion unit 100 analyzes the scenario specification provided as an input, selects a predetermined pattern among message exchange patterns described in FIGS. 5A to 5C (410), and converts the selected pattern to an unified modeling language (UML) activity diagram by use of a conversion rule (420).

Thereafter, the test model conversion unit 100 generates a start label and an end label each having a unique number at a start point and an end point of a fragment of each activity diagram, respectively (430). The start label of the current pattern has the same label number as that of the end label of a previous pattern. The test model conversion unit 100 connects activity diagrams having the same label number to each other, thereby generating the entire activity diagram (440).

Then, the test model conversion unit 100 adds a start node and an end node to the entire activity diagram, and removes unnecessary start label and end label, which are provided in the middle between the start node and the end node, from the activity diagram (450). Pre-condition information and post-condition information for input/output variables are added to each message event in the form of an UML OCL (Object Constraints Language) (460).

FIGS. 5A to 5C are views illustrating a process of converting a message sequence chart to an activity diagram.

Referring to FIGS. 5A to 5C, the test model conversion unit 100 analyzes the scenario specification to classify message exchange schemes between communication objects into message exchange patterns. The communication objects may be two component services or may be an application and a component service.

The test model conversion unit 100 converts classified each message exchange pattern of the scenario specification, for example, a MSC fragment, to a test model, for example, an UML Activity Diagram.

The message exchange patterns may include a message exchange pattern I (one-way) shown in FIG. 5A, a message exchange pattern II (two-way) shown in FIG. 5B and a message exchange pattern III (request-response) shown in FIG. 5C. The message exchange pattern III is a two-way pattern receiving two types of responses.

In the activity diagrams shown in FIGS. 5A to 5C, messages (msg 1, msg2 and msg 3) represent ‘activities’ and a long dark square represents a ‘concurrent path’. In processing the activities, some activities having been simultaneously executed may converge. In this case, a part of executing two paths of the activities is denoted as a long dark square. In addition, a part where two paths converge is also denoted as a long dark square. An arrow represents a direction of process. The diamond shown in FIG. 5C represents a ‘conditional’ step. A part divided depending on a ‘conditional’ represents a ‘decision’ step and denoted as a diamond symbol.

FIG. 6 is a flowchart showing an example of a process of generating a test case.

Referring to FIG. 6, a test case generating unit 110 generates a Control Flow Graph (CFG) from an UML activity diagram (600). Nodes of the CFG represent a transmission message event and a reception message event of the UML activity diagram, and an edge of the CFG represents the message exchange sequence.

Thereafter, the test case generating unit 110 adds a preamble and a postamble for each node of the CFG (610). The preamble represents the shorted path from the start node to the current node in the CFG, and the post-amble represents the shorted path from the current node to the start node.

The test case generating unit 110 analyzes pre-condition and post-condition of OCL at each node and edge of the CFG to generate all paths between a defined position and a used position of all variables (620).

The test case generating unit 110 removes redundant paths (630), and adds a preamble and a post-amble to the generated path, thereby generating a complete path (640). Then, a test case corresponding to the generated complete path is generated (650), and allocates a predetermined value to input parameters of the test case.

In the above examples, each part shown in the accompanying drawings may be implemented as a ‘module’. The ‘module’ performs a predetermined function and may represent a software element or a hardware element such as a Programmable Gate Array (FPGA) or an Application Specific Integrated Circuit (ASIC). However, the ‘module’ is not limited thereto. For example, ‘module’ may be implemented in an addressable storage medium, or may be formed to execute one or more processors. Each of elements and modules may provide functions that can be integrated along with the integration into a smaller number of elements and modules or can be divided along with dividing into additional elements and modules.

Although an exemplary embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. An apparatus for integrated testing of a service based application, the apparatus comprising an application integrated testing unit configured to analyze a control flow and a data flow, which are generated from an interaction between at least one component service and a service based application, and perform an integrated test on the at least one component service and the service based application based on a result of the analysis.

2. The apparatus of claim 1, wherein the component service provides the service based application with data and service in a logical function unit, and the service based application is provided in the form of a composition of the at least one component service.

3. The apparatus of claim 1, wherein the application integrated testing unit comprises:
is a test model conversion unit configured to convert a scenario specification, which represents an interaction between the component service and the application with time, to a test model, which represents a flow of activities performed by the component service and the application; and
a test cast generating configured to generate a test case from the converted test model, which is the test case used to test whether the component service and the application are normally provided.

4. The apparatus of claim 3, wherein the test mode conversion unit converts the scenario specification to the test model by use of an activity diagram of an unified modeling language.

5. The apparatus of claim 3, wherein the test model conversion unit comprises an activity diagram conversion unit configured to select a predetermined pattern among message exchange patterns of the scenario specification, convert the selected predetermined pattern to an activity diagram corresponding to the test model, generate a start label and an end label before and after a message event, respectively, at each activity diagram, and connect activity diagrams having the same label, thereby generating an entire activity diagram.

6. The apparatus of claim 5, wherein the test model conversion unit comprises:
a pre-processing unit which is provided before the activity diagram conversion unit to define a swim lane for each object of the scenario specification; and
a post-processing unit which is provided after the activity diagram conversion unit to generate a start node and an end node of the generated entire diagram, remove the start label and the end label and add pre-condition information and post-condition information about input variables and output variables to the message event.

7. The apparatus of claim 3, wherein the test case generating unit generates a control flow graph from the converted text model, adds a preamble and a post-amble for each node of the generated control flow graph, generates a path between a defined location and a used location for input variables and output variables at each node, adds a preamble and a post-amble to the generated path to generate a complete path, thereby generating a test case corresponding to the generated complete path.

8. The apparatus of claim 3, further comprising:
a test case execution unit configured to perform integrated testing on the component service and the service based application by use of the test case.

9. The apparatus of claim 8, wherein the test case execution unit tests whether a web service message between the component service and the service based application satisfies a messaging procedure and input/output values, which are described in the test case.

10. The apparatus of claim 8, wherein the test case execution unit comprises at least one of a storage unit to store a result of testing and an output unit configured to output a result of testing.

11. A system for integrated testing of a service based application, the system comprising:
at least one component service apparatus configured to provide component services;
is an application apparatus configured to provide a service based application which is composed of the at least one component service; and
an application integrated testing apparatus configured to generate a test case based on a control flow and a data flow, which are generated from an interaction between the component service apparatus and the application apparatus, executes the generated test case to perform the integrated testing on the component service and the service based application.

12. The system of claim 11, wherein the application integrated testing apparatus comprises:
a testing apparatus configured to execute the test case to test whether a web service message transmitted and received between the testing apparatus and the application apparatus satisfies a messaging procedure and input/output values that are described in the test case; and a testing monitor configured, when the test case is executed, to test whether a web service transmitted and received between the component service apparatus and the application apparatus satisfies a messaging procedure and input/output values that are described in the test case.

13. The system of claim 11, wherein the application integrated testing apparatus converts a scenario specification between the component service apparatus and the application apparatus to a test model, which represents an activity flow between the component service apparatus and the application apparatus, and generates the test case from the converted test model.

14. A method for integrated testing of a service based application, the method comprising:
at a test model converting unit, converting a scenario specification between at least one component service apparatus and a service based application apparatus to a test model, which represents an activity flow between the component service apparatus and the service based application apparatus; and
at a test case generating unit, generating a test case from the converted test model.

15. The method of claim 14, wherein in the converting to the test model comprises:
selecting a predetermined pattern among message exchange patterns of the scenario specification;
converting the selected predetermined pattern to an activity diagram corresponding to the test model; and
generating an entire activity diagram by generating a start label and an end label before and after a message event, respectively, at each activity diagram and connecting activity diagrams having the same label to each other.

16. The method of claim 14, wherein the generating of the test case comprises:
generating a control flow graph from the converted test model;
adding a preamble and a postamble for each node of the generated control flow graph and generating a path between a defined location and a used location of input/output variables at each node; and
adding a preamble and a postamble to the generated path to generate a complete path, thereby generating a test case corresponding to the generated complete path.

17. The method of claim 14, further comprises:
at a test case execution unit, performing integrated testing on the component service and the service based application by use of the test case.

18. The method of claim 17, wherein the performing of the integrated testing comprises:
at a testing apparatus, executing the test case to test whether a web service message transmitted and received between the testing apparatus and the service based application apparatus satisfies a messaging procedure and input/output values that are described in the test case; and
upon the execution of the test case, at a testing monitor testing whether a web service transmitted and received between the component service apparatus and the service based application apparatus satisfies a messaging procedure and input/output values that are described in the test case.
